(19) United States
(12) Patent Application Publication
(10) Pub. No.: US 2023/0091667 A1
(43) Pub. Date: Mar. 23, 2023

(54) CUSTOMIZATION OF SOFTWARE APPLICATIONS WITH NEURAL NETWORK-BASED FEATURES

(71) Applicant: SONY GROUP CORPORATION, Tokyo (JP)

(72) Inventors: KRISHNA PRASAD AGARA VENKATESHA RAO, Bangalore (IN); Santosh Eraniose, Bangalore (IN)

(21) Appl. No.: 17/481,958

(22) Filed: Sep. 22, 2021

(51) Int. Cl. G06N 3/04; G06N 3/08

(52) U.S. Cl. CPC G06N 3/0454; G06N 3/082

(57) ABSTRACT

A system and method for customization of software applications with neural network-based features is disclosed. The system acquires information related to one or more functional components of an electronic device and usage data associated with the electronic device. The system selects a computer vision task, based on the acquired information and the usage data, and determines constraints associated with an implementation of the selected computer vision task on the electronic device. The system selects a first neural network as a seed model for the selected computer vision task and execute operations, including a neural architecture search with the seed model and the constraints as input, to obtain a second neural network which is trained on the selected computer vision task. The system updates a software application on the electronic device to include an end-user feature that implements the second neural network for the selected computer vision task.

### CROSS-REFERENCE TO RELATED APPLICATIONS/INCORPORATION BY REFERENCE

None.

### FIELD

Various embodiments of the disclosure relate to deep learning, image processing, and software customization. More specifically, various embodiments of the disclosure relate to a system and method for customization of software applications with neural network-based features.

### BACKGROUND

Advancements in the field of computer vision and deep learning have led to development of various customizations or advanced features for software applications, which may be available on electronic devices, such as a mobile phone or a camera. For example, a camera may include an imaging application to shoot pictures and videos. On some devices, the imaging application may include features, such as face detection, object classification, image segmentation, and image masking. In some scenarios, developers may develop features or updates for devices based on requirements, such as a specific hardware specification, a device cost, or a device launch date. Such features or updates may not be developed and made available for other devices that don't meet the requirements. For example, it may be challenging to port new artificial intelligence (AI)-based features on old hardware with a limited memory as AI models can be very resource hungry and need computational power and memory. In some other scenarios, a fixed version of software with common updates may be pushed on all versions or models of devices. In such scenarios, both devices, i.e., a higher-spec device and a lower-spec device may receive the same updates. While such updates may be useful, they may lack granularity and may not be of interest to all users.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for customization of software applications with neural network-based features is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for customization of software applications with neural network-based features, in accordance with an embodiment of the disclosure.

FIG. 2 is a block diagram that illustrates an exemplary system, in accordance with an embodiment of the disclosure.

FIGS. 3A, 3B, and 3C collectively depict a diagram that illustrates an exemplary processing pipeline for customization of software applications with neural network-based features, in accordance with an embodiment of the disclosure.

FIG. 4 is a diagram that illustrates an exemplary user interface for customization of software applications with neural network-based features, in accordance with an embodiment of the disclosure.

FIG. 5 is a diagram that illustrates an exemplary user interface for customization of software applications with neural network-based features, in accordance with an embodiment of the disclosure.

FIG. 6 is a diagram that illustrates an exemplary scenario for customization of software applications with neural network-based features, in accordance with an embodiment of the disclosure.

FIG. 7 is a diagram that illustrates exemplary scenario for customization of software applications with neural network-based features, in accordance with an embodiment of the disclosure.

FIG. 8 is a flowchart that illustrates exemplary operations for customization of software applications with neural network-based features, in accordance with an embodiment of the disclosure.

### DETAILED DESCRIPTION

The following described implementation may be found in the disclosed system and method for customization of software applications with neural network-based features. Exemplary aspects of the disclosure provide a system, which may update a software application on an electronic device with neural network-based features. As an example, the electronic device may be an image-capture device and the software application may be an imaging software installed on the electronic device.

The system may be configured to acquire information related to one or more functional components of the electronic device. The acquired information may include, for example, hardware specification of the one or more functional components, and cost information associated with the one or more functional components. The system may be configured to further acquire usage data associated with the electronic device. The acquired usage data may include, for example, a digital footprint of the user on the software application, a set of category tags related to image-based content created through the software application, a user preference for the image-based content on the electronic device, and a usage pattern of existing functionalities that implement a type of neural network for one or more computer vision tasks.

The system may be configured to select a computer vision task based on the acquired information and the usage data and determine a set of constraints associated with an implementation of the selected computer vision task on the electronic device. The computer vision task may include, for example, an object classification task, an object detection task, a color enhancement task, or a face detection task. For the selected computer vision task, the system may select a first neural network as a seed model and may execute one or more operations, including but not limited to, a neural architecture search with the seed model and the set of constraints as input. The operations may be executed to obtain a second neural network, which may be trained on the selected computer vision task.

The system may be configured to update a software application on the electronic device to include an end-user feature that implements the second neural network for the selected computer vision task. The update of the software application may include, for example, a replacement of an existing neural network model on the electronic device with the second neural network, an installation of the second neural network as a component of the software application on the electronic device, and an update of parameters, including weight parameters of an existing neural network on the electronic device with that of the second neural network.

The disclosed system may automatically determine the set of constraints associated with the implementation of the selected computer vision task on the electronic device. Based on the determined set of constraints, the disclosed system may customize the software application with neural network-based features, thereby eliminating human intervention and additional hardware requirements to implement such features. The disclosed system may obtain an optimum second neural network using neural architecture search. Based on the obtained second neural network, the disclosed system may update a software application on the electronic device to include an end-user feature that implements the second neural network. The update of the software application may enrich existing functionalities offered by the electronic device or may provide new functionalities, without a need to upgrade the electronic device.

The disclosed system may allow the user to select granularity of the update for the software application. For example, if a new version of a software application is available, the system may be configured to provide options indicative of a set of end-user features for which the software application may be updated. The user may select at least one end-user feature from the set of end-user features.

The disclosed system may further provide a personalized set of end-user features for the selection based on acquired usage data. The set of features may be made available for purchase or subscription based on the acquired information, the usage data, an estimated demand for the end-user feature, and business intelligence data on users of the electronic device. This may allow personalization of the end-user feature selection.

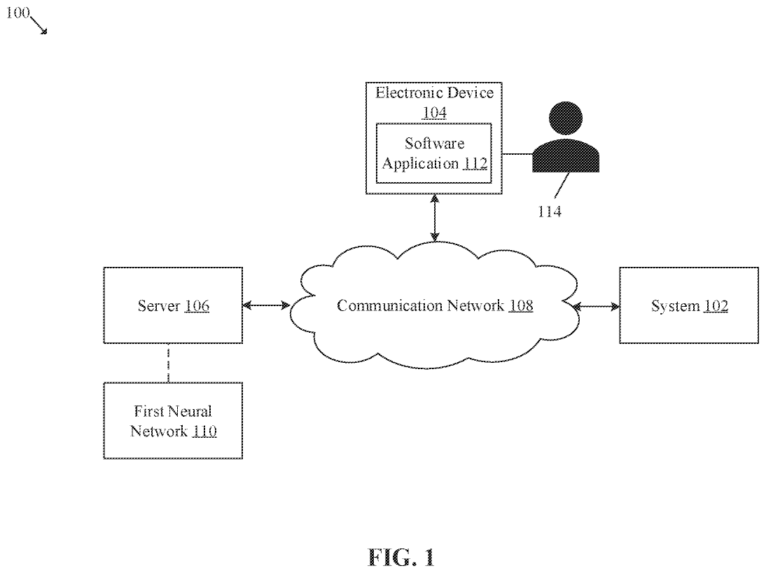

FIG. 1 is a block diagram that illustrates an exemplary network environment for customization of software applications with neural network-based features, in accordance with an embodiment of the disclosure. With reference to FIG. 1, there is shown a network environment 100. The network environment 100 may include a system 102, an electronic device 104, and a server 106. The server 106 may include a collection of neural network models for different computer vision tasks. As shown, for example, a first neural network 110 is stored on the server 106. The electronic device 104 may include one or more software applications, such as a software application 112 for various applications, such as, image-capture, photo editing, video editing, and computer/machine vision. The system 102, the electronic device 104, and the server 106 may be communicatively coupled to each other, via a communication network 108. In the network environment 100, there is further shown a user 114 who may be associated with the electronic device 104.

The system 102 may include suitable logic, circuitry, interfaces, and/or code that may be configured to train/develop neural networks for various computer vision tasks and determine end-user features that implement such neural networks on user devices (such as the electronic device 104). Such tasks may be determined based on various factors, such as hardware/cost constraints associated with user devices (such as the electronic device 104), user preferences, or user data/activity on the user devices. Such end-user features may be included in software applications on the user devices through over-the-air (OTA) updates. Examples of the system 102 may include, but are not limited to, a computing device, a smartphone, a mobile device, a tablet, a laptop, a gaming device, a mainframe machine, a server, a computer work-station, and/or an edge computing device.

The electronic device 104 may include suitable logic, circuitry, interfaces, and/or code that may be configured to execute operations related to various image-based applications. Example of such image-based applications may include, but is not limited to, image/video acquisition, image/video editing, face detection, object detection/classification, image segmentation, object tracking, object localization, style transfer, image coloring, and 3D reconstruction. In an embodiment, the electronic device 104 may include a software application 112, installed or accessible through a web client, such as a web browser. Examples of the electronic device 104 may include, but are not limited to, a smartphone, a mobile phone, a tablet, a laptop, a gaming device, a camera device, and/or a consumer electronic (CE) device. The camera device may include, but are not limited to, a wide-angle camera, an action camera, a closed-circuit television (CCTV) camera, a camcorder, a digital camera, a camera phone, a time-of-flight camera (ToF camera), a night-vision camera, and/or another image capture device.

The first neural network 110 may be a deep learning model that may be directly trained on a computer vision task or may be used as a seed model to generate a second neural network trained on the computer vision task. The first neural network 110 may be defined by its neural network topology and hyper-parameters, for example, activation function(s), number of weights, cost function, regularization function, input size, number of layers, and the like. The first neural network 110 may be referred to as a computational network or a system of artificial neurons (also referred to as nodes). The nodes of the first neural network 110 may be arranged in a plurality of layers, as defined in a neural network topology of the first neural network 110. The plurality of layers of the first neural network 110 may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the first neural network 110. Outputs of each hidden layer may be coupled to inputs of at least one node in other layers of the first neural network 110. Node(s) in the final layer may receive inputs from at least one hidden layer to output a result. The number of layers and the number of nodes in each layer may be determined from the hyper-parameters of the first neural network 110. Such hyper-parameters may be set before or while training the first neural network 110 on a training dataset.

Each node of the first neural network 110 may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the first neural network 110. All or some of the nodes of the first neural network 110 may correspond to same or a different mathematical function.

In training of the first neural network 110, one or more parameters of each node of the first neural network 110 may be updated based on whether an output of the final layer for a given input (from the training dataset) matches a correct result based on a loss function for the first neural network 110. The above process may be repeated for same or a different input till a minima of loss function is achieved, and a training error is minimized. Several methods for training are known in the art, for example, gradient descent, stochastic gradient descent, batch gradient descent, gradient boost, meta-heuristics, and the like.

In an embodiment, the first neural network 110 may include electronic data, which may be implemented as, for example, a software component of an application executable on the system 102. The first neural network 110 may rely on libraries, external scripts, or other logic/instructions for execution by a processing device, such as the system 102. The first neural network 110 may include computer-executable codes or routines to enable a computing device, such as the system 102 to perform one or more operations to perform a computer vision task. Additionally, or alternatively, the first neural network 110 may be implemented using hardware including a processor, a microprocessor (e.g., to perform or control performance of one or more operations), a field-programmable gate array (FPGA), an Artificial Intelligence (Al) accelerator such as a vision processing unit (VPU), a or an application-specific integrated circuit (ASIC). For example, an inference accelerator chip may be included in the system 102 to accelerate computations of the first neural network 110 for the computer vision task that may include the end-user feature. In some embodiments, the first neural network 110 may be implemented using a combination of both hardware and software.

Examples of the first neural network 110 may include, but are not limited to, an artificial neural network (ANN), a convolutional neural network (CNN), Regions with CNN (R-CNN), Fast R-CNN, Faster R-CNN, a You Only Look Once (YOLO) network, a Residual Neural Network (Res-Net), a Feature Pyramid Network (FPN), a Retina-Net, a Single Shot Detector (SSD), and/or a combination thereof. In an embodiment, the first neural network 110 may be a deep neural network (DNN) or a combination of multiple variants of DNN.

The server 106 may include suitable logic, circuitry, and interfaces, and/or code that may be configured to store the first neural network 110. The server 106 may further store information related to one or more functional components of an electronic device 104, and usage data associated with the electronic device 104. In an exemplary embodiment, the server 106 may be implemented as a cloud server and may execute operations through web applications, cloud applications, HTTP requests, repository operations, file transfer, and the like. Other example implementations of the server 106 may include, but are not limited to, a database server, a file server, a web server, an application server, a mainframe server, or a cloud computing server.

In an embodiment, the server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106 and the system 102 as two separate entities. In certain embodiments, the functionalities of the server 106 can be incorporated in its entirety or at least partially in the system 102, without a departure from the scope of the disclosure.

The communication network 108 may include a communication medium through which the system 102, the electronic device 104, and the server 106 may communicate with one another. Examples of the communication network 108 may include, but are not limited to, the Internet, a cloud network, a Wireless Local Area Network (WLAN), a Wireless Fidelity (Wi-Fi) network, a Personal Area Network (PAN), a Local Area Network (LAN), a telephone line (POTS), and/or a Metropolitan Area Network (MAN), a mobile wireless network, such as a Long-Term Evolution (LTE) network (for example, 4th Generation or 5th Generation (5G) mobile network (i.e., 5G New Radio)). Various devices in the network environment 100 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, or Bluetooth (BT) communication protocols, or a combination thereof.

In operation, the system 102 may be configured to acquire information related to one or more functional components of the electronic device 104. The one or more functional components of the electronic device 104 may include one or more hardware or software components. Examples of the hardware components may include, but are not limited to, one or more image sensors, a shutter, a display device, a memory, a battery, a microprocessor, a Graphics Processing Unit (GPU), a video codec chip, and a co-processor such as an AI accelerator chip. Similarly, examples of the software components may include, but are not limited to, a video or image codec (software), a device driver software, an operating system, and a device firmware.

The acquired information may include, for example, a hardware specification of the one or more functional components and cost information associated with the one or more functional components. In an embodiment, the hardware specification of the one or more functional components may include a technical description of features or indicators which affect a performance and an execution of software applications (such as the software application 112) on the electronic device 104. Such features or indicators may include, for example, a size of cache memory, a size of read and write memory (RAM), a size of permanent data storage, a processor speed, a number of floating point operations (FLOPS) supported by the GPU or the microprocessor, a number of GPU cores, a display resolution, a shader version, a size or a version/model of the image sensor, a device driver version, a firmware version, a codec version, an OS version, and the like. The cost information associated with the one or more functional components may include a market price or a selling price of each individual functional component. In an embodiment, the acquired information may include a model name under which the electronic device 104 is/was launched in the market, a market price of the electronic device 104 at present or at the time of the launch, a product launch date associated with the electronic device 104, and an indication of whether or not the model of the electronic device 104 is still in production or sold in the market.

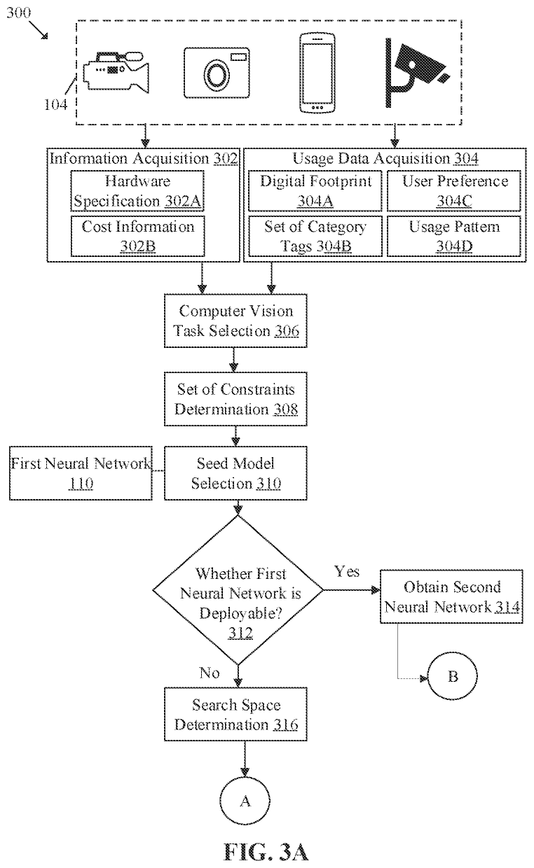

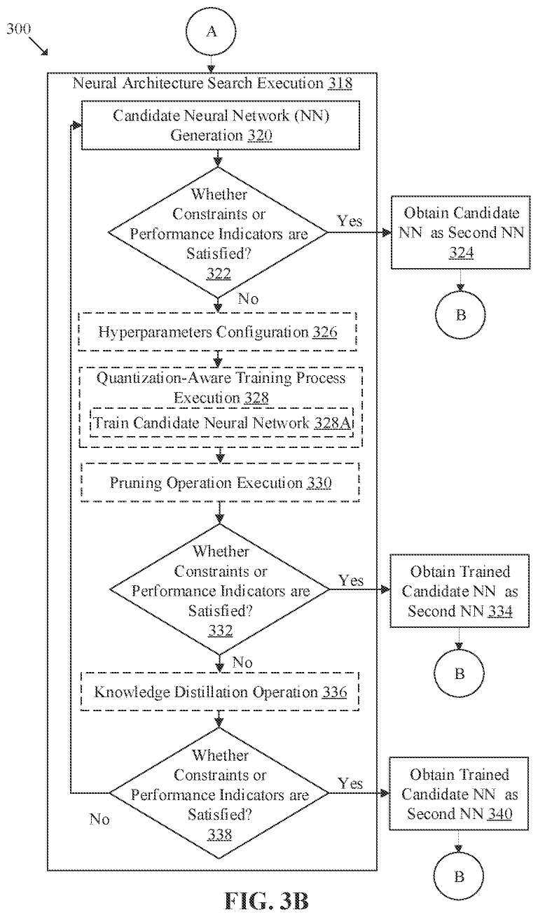

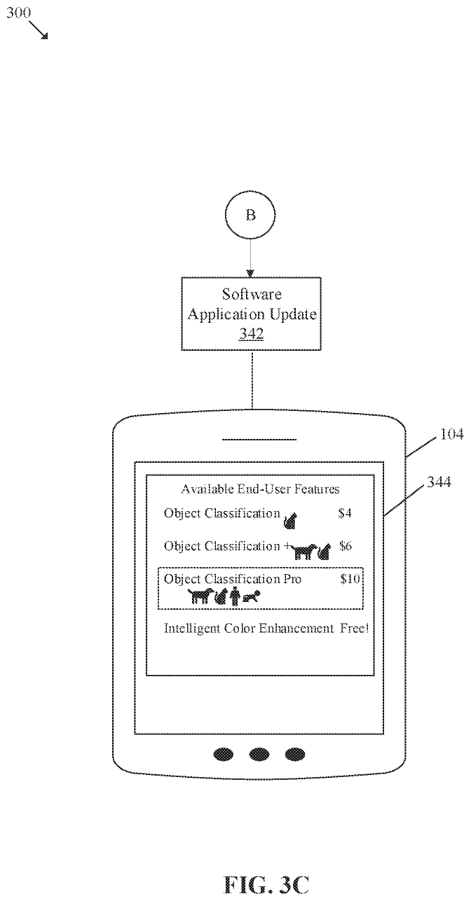

The system may be configured to acquire usage data associated with the electronic device 104. As an example, the acquired usage data may include a digital footprint of the user 114 on the software application, a set of category tags related to image-based content created through the software application, a user preference for the image-based content on the electronic device 104, and a usage pattern of existing functionalities that implement a type of neural network for one or more computer vision tasks. The acquisition of the usage data associated with the electronic device 104 is described, for example, in FIG. 3A.

The system 102 may be configured to select a computer vision task based on the acquired information and the usage data. By way of example, and not limitation, the usage data and the acquired information may be mined to determine a type of object that the user 114 may be interested in while doing photography or a computer vision task that the user 114 may want to have in the imaging application as a feature to improve or enhance his/her productivity while using the imaging application. The computer vision task may include but not limited to, object classification, object detection, optical character recognition, pose detection, image/video enhancement, object tracking in images/videos, synthesis of a description for objects in images/videos, neural style transfer, colorization or color enhancement, synthetic image/video generation, image segmentation or mask generation, face detection, and 3D reconstruction.

The system 102 may be further configured to determine a set of constraints associated with an implementation of the selected computer vision task on the electronic device 104. As an example, the set of constraints may include one or more hardware-specific constraints, one or more cost constraints, and one or more performance indicators. The selection of the computer vision task and determination of the set of constraints, is described, for example, in FIG. 3A.

The system 102 may be configured to select a first neural network 110 as a seed model for the selected computer vision task, as described, for example, in FIG. 3A. Thereafter, the system 102 may be configured to execute one or more operations, including a neural architecture search (NAS) with the seed model and the set of constraints as an input. The operations may be executed to obtain a second neural network, which may be trained on the selected computer vision task. The second neural network may be optimized for execution on the electronic device 104 with a zero to a minimum violation of the determined set of constraints. The execution of the one or more operations is described, for example, in FIGS. 3A, and 3B.

The system 102 may be further configured to update the software application 112 on the electronic device 104 to include an end-user feature that implements the second neural network for the selected computer vision task. The update of the software application 112 may include, but is not limited to, a replacement of an existing neural network model on the electronic device 104 with the second neural network, an installation of the second neural network as a component of the software application 112, and an update of parameters, including weight parameters of an existing neural network on the electronic device with that of the second neural network. The update of the software application 112 on the electronic device 104, is described, for example, in FIG. 3C.

Since the second neural network is obtained for execution on the electronic device 104 (and devices which have similar hardware specs or are of same model), the update may help the user 114 to enjoy end-user features traditionally not available on the electronic devices 104 because of hardware constraints or cost constraints. Since the system 102 acquires both the usage data and device-specific information (i.e. the acquired information), the determination of the computer vision task (that the user 114 may be interested in) and the set of constraints on the execution of the computer vision task can be automated. This may enable the system 102 to provide the user 114 with more granular/user-specific end-user features that satisfy various needs of the user 114 and cause zero to a minimum violation of constraints. The automatic update of the software application 112 may help the developers of the software application 112 to avoid putting any additional effort to develop end-user features that satisfy both the user needs and the constraints. Such features may be made available for execution on the electronic device 104, without any additional hardware requirements, hardware upgrade, or a manual customization of the software application 112.

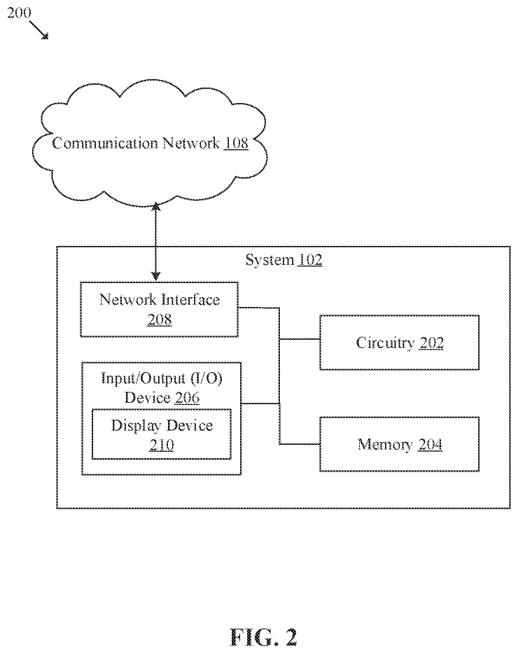

FIG. 2 is a block diagram that illustrates an exemplary system, in accordance with an embodiment of the disclosure. FIG. 2 is explained in conjunction with elements from FIG. 1. With reference to FIG. 2, there is shown the system 102. The system 102 may include circuitry 202, a memory 204, an input/output (I/O) device 206, and a network interface 208. The I/O device 206 may include the display device 210. The network interface 208 may connect the system 102 with the electronic device 104, and the server 106, via the communication network 108.

The circuitry 202 may include suitable logic, circuitry, and/or interfaces that may be configured to execute program instructions associated with different operations to be executed by the system 102. The circuitry 202 may include one or more specialized processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The memory 204 may be configured to store the first neural network 110. The memory 204 may be further configured to store one or more of, but not limited to, information related to one or more functional components of the electronic device 104, the usage data associated with the electronic device 104, and the set of constraints. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. The I/O device 206 may include various input and output devices, which may be configured to communicate with the circuitry 202. In an example, the system 102 may receive (via the I/O device 206) the user input indicative of a first option to purchase the end-user feature. In another example, the system 102 may receive (via the I/O device 206) the user input indicative of a second option to subscribe to the end-user feature. Examples of the I/O device 206 may include, but are not limited to, a touch screen, a keyboard, a mouse, a joystick, a display device (for example, the display device 210), a microphone, or a speaker.

The display device 210 may include suitable logic, circuitry, and interfaces that may be configured to display an output of the system 102. The display device 210 may be utilized to display a User Interface (UI) that may include, but not limited to the first option to purchase the end-user feature, the second option to subscribe to the end-user feature, a description that includes an accuracy of the second neural network and details of device resources that the end-user feature is likely to consume, and a price associated with each of the first option and the second option. In some embodiments, the display device 210 may be an external display device associated with the system 102. The display device 210 may be a touch screen which may enable the user 114 to provide a user input via the display device 210. The touch screen may be at least one of a resistive touch screen, a capacitive touch screen, a thermal touch screen or any other touch screen using which inputs can be provided to the display device 210. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices.

The network interface 208 may include suitable logic, circuitry, interfaces, and/or code that may be configured to facilitate communication between the system 102, the electronic device 104, and the server 106, via the communication network 108. The network interface 208 may be implemented by use of various known technologies to support wired or wireless communication of the electronic device 104 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS). Various operations of the circuitry 202 for audio recommendation based on script information and video content are described further, for example, in FIGS. 3A, 3B, 3C, 4, 5, 6, and 7.

FIGS. 3A, 3B, and 3C collectively depict a diagram that illustrates an exemplary processing pipeline for customization of software applications with neural network-based features, in accordance with an embodiment of the disclosure. FIGS. 3A, 3B, and 3C are described in conjunction with elements from FIGS. 1 and 2. With reference to FIGS. 3A, 3B, and 3C, there is shown a processing pipeline 300. The processing pipeline 300 may include operations from 302 to 342 to depict customization of software applications with neural network-based features. The circuitry 202 may execute the operations from 302 to 342.

At 302, information may be acquired. In an embodiment, the circuitry 202 may be configured to acquire the information related to one or more functional components of an electronic device 104. The information may be acquired from a specification record stored on the server 106 or on the electronic device 104. Additionally, or alternatively, the information may be acquired from benchmarking data of the electronic device 104.

In an embodiment, the circuitry 202 may control the I/O device 206 to acquire the information based on a user input. As an example, the user input may specify a hardware or software specification and other performance indicators of the electronic device 104. As another example, the user input may include a unique identification number of the electronic device 104, a model number of the electronic device 104, a model name of the electronic device 104, and a cost of the electronic device 104.

In an embodiment, the electronic device 104 may be implemented as an image-capture device. Examples of the image capture device may include, but are not limited to, a wide-angle camera, an action camera, a closed-circuit television (CCTV) camera, a camcorder, a digital camera, a camera phone, a time-of-flight camera (ToF camera), or a night-vision camera. The acquired information may include, but is not limited to, hardware specification 302A of the one or more functional components and cost information 302B associated with the one or more functional components. The hardware specification of the one or more functional components may include a technical description of features or indicators which affect a performance and an execution of software applications (such as the software application 112) on the electronic device 104. Such features or indicators may include, for example, a size of cache memory, a size of read and write memory (RAM), a size of permanent data storage, a processor speed, a number of floating point operations (FLOPS) supported by the GPU or the microprocessor, a number of GPU cores, a display resolution, a shader version, a size or a version/model of the image sensor, a device driver version, a firmware version, a codec version, an OS version, and the like. The cost information associated with the one or more functional components may include a market price or a selling price of each individual functional component.

At 304, usage data may be acquired. In an embodiment, the circuitry 202 may be configured to acquire the usage data associated with the electronic device 104. For example, the circuitry 202 may control the I/O device 206 to acquire the usage data based on a user input received from the user 114. The user input may indicate a user preference to work with or create image-based content on the electronic device 104. Additionally, or alternatively, the usage data may be acquired based on data mining and analysis of data, such as user activity logs stored on the electronic device 104, image-based content recently/historically created or stored on the electronic device 104, and a user activity on messaging or social media platforms.

The acquired usage data may include, but is not limited to, a digital footprint 304A on the software application 112, a set of category tags 304B related to the image-based content created through the software application 112, a user preference 304C for the image-based content on the electronic device 104, and a usage pattern 304D of existing functionalities that implement a type of neural network for one or more computer vision tasks. For example, the digital footprint 304A on the software application 112 may be indicative of past or recent user activities on the software application 112. In some instances, the digital footprint 304A may be acquired from logs of user activity on various platforms, such as websites, smartphone applications, social media application, or from various data aggregators. For example, the user 114 may click an image of a bird through an imaging software of the electronic device 104 and may upload the image to a social media platform. The user may add tags and may comment/discuss about the image with other users of the social media platform. The comments, the tags, the image of the bird, and the action to upload may be included in the usage data.

In an embodiment, the software application 112 may be implemented as an imaging software installed on the electronic device 104. The circuitry 202 may acquire the digital footprint 304A on the software application 112 as the usage data. The set of category tags 304B related to image-based content created through the software application 112 may be indicative of categories or tags determined based on the images captured using the electronic device 104. In an embodiment, the circuitry 202 may control the software application 112 on the electronic device 104 to collect the set of category tags 304B. The set of category tags 304B may include, but is not limited to, fashion, sports, editorial, animal, or wedding.

The user preference 304C for the image-based content on the electronic device 104 may include a user preference to capture the image. In an embodiment, the circuitry 202 may acquire the user preference 304C from images captured using the electronic device 104. The user preference 304C may include, but is not limited to, a portrait photography, a fashion photography, a sports photography, a landscape photography, an animal photography, or a wedding photography. In an embodiment, the user preference 304C may be acquired from the digital footprint 304A on the software application 112, the set of category tags 304B, or the usage pattern 304D of existing functionalities that implement a type of neural network for one or more computer vision tasks. The usage pattern 304D of the existing functionalities that implement a type of neural network for one or more computer vision tasks may include a functionality name from the existing functionalities that may be frequently used by the user 114 for the for one or more computer vision tasks. For example, the existing functionalities may include auto-tagging/captioning images, auto focus, auto balance, auto exposure, or a face detection.

At 306, a computer vision task may be selected. In an embodiment, the circuitry 202 may be configured to select a computer vision task, based on the acquired information (at 302) and the usage data (at 304). The computer vision task may be a task to process or analyze the images captured by the electronic device 104 and to generate synthetic images (using adversarial learning) or inferences (such as classification/regression results) from the analysis.

On the electronic device 104, the selected computer vision task may be implemented as an end-user feature of one or more software applications. The end-user feature may be accessible via a user interface (UI) element, which may be rendered on a UI of a software application of the electronic device 104. Examples of the selected computer vision task may include, but are not limited to, object classification, image segmentation, semantic segmentation/panoptic segmentation, pose detection, object detection, image/video enhancement, style transfer, image colorization, color enhancement, face detection, object tracking in videos, and 3D reconstruction.

In an embodiment, the circuitry 202 may be configured to analyze the acquired information and the usage data and select the computer vision task based on the analysis. Based on the analysis of the acquired information, the circuitry 202 may be configured to determine hardware specification of the one or more functional components of the electronic device 104. The determination of the hardware specification may enable the circuitry 202 to determine available hardware resources, such as temporary memory and storage. Such resources may put constraints on availability of functionalities/end-user features for the electronic device 104 and may determine a compatibility of the electronic device 104 with the functionalities.

The circuitry 202 may be further configured to determine the user preferences corresponding to a type of image captured by the electronic device 104 based on the analysis of the acquired usage data. Thereafter, the circuitry 202 may be configured to select the computer vision task. For example, the acquired information includes a Single-lens Translucent (SLT) camera released in September 2020 and the usage data include the user preference 304C for animal-based image content (such as wildlife photography). The circuitry 202 may be configured to select the computer vision task as animal classification task, a special case of multi-object classification.

At 308, a set of constraints may be determined. In an embodiment, the circuitry 202 may be configured to determine the set of constraints associated with an implementation of the selected computer vision task on the electronic device 104. In an example, the set of constraints may include, but is not limited to, one or more hardware-specific constraints, one or more cost constraints, and one or more performance indicators. The one or more hardware-specific constraints may be determined based on the hardware specification. For example, the one or more hardware-specific constraints may include hardware limitations associated with memory space, compute-capability (e.g. in terms of number of cores/FLOPS), battery usage, display capability, shutter lag, zooming capability, graphic processing capability, microprocessor capability, and the like. Such hardware-specific constraints may include information, such as available memory or space to upgrade the functionalities of the electronic device 104 and compatibility of the electronic device 104 with the functionalities. The one or more cost constraints may be determined based on the cost information. For example, the one or more cost constraints may include, but not limited to, a cost associated with one or more functional components of the electronic device 104 or one or more end-user features (such as face detection or pet animal classification). Additionally, or alternatively, such cost constraints may include information, such as a cost associated with a development of the functionalities/end-user features for the electronic device 104 and the cost of the electronic device 104 at the time of launch in the market. The one or more performance indicators may specify factors, such as a desired speed and accuracy in application of the computer vision task on the electronic device 104.

At 310, a seed model may be selected. In an embodiment, the circuitry 202 may be configured to select the first neural network 110 as a seed model for the selected computer vision task. The first neural network 110 may be an untrained model, a trained model on a similar computer vision task, or a pre-trained on the selected computer vision task. In an embodiment, the seed model may be selected from a data source. The data source may include, for example, a memory (such as the memory 204) on the electronic device 104, a cloud server (such as the server 106) that maintains a repository of seed models, or a combination thereof. In an embodiment, the seed model may be acquired for the selected computer vision task from an open source repository of models, stored on the server 106. The circuitry 202 may be configured to select and extract the seed model from the server 106.

At 312, it may be determined whether the first neural network 110 is deployable. In an embodiment, the circuitry 202 may be configured to determine whether the first neural network 110 as the seed model is deployable, without training or changes in the layers of the seed model. The first neural network 110 may be determined to be deployable if the first neural network 110 as the seed model satisfies the determined set of constraints and is pre-trained on the selected computer vision task. Additionally, or alternatively, the first neural network 110 may be determined to be deployable if the first neural network incurs a violation of the constraints within a permissible range. For example, the size of the first neural network 110 may be 10 MB, which may exceed a storage constraint of 8 MB by additional 2 MB. Even though the size violates the storage constraint, the additional 2 MB space may be determined to be within a permissible range for deployment.

In an embodiment, the circuitry 202 may be configured to compare the determined set of constraints and device resources that the first neural network 110 (as part of a new end-user feature of the software application 112) may likely consume on the electronic device 104. When the determined set of constraints and the device resources match, the circuitry 202 may be configured to deploy the first neural network 110. For example, if the set of constraints includes a memory or storage size of 50 Megabytes (MB) as a hardware-specific constraint and the storage size (i.e. a device resource needed by the first neural network 110) is 25 MB (which is less than the available memory or storage size on the electronic device 104), then control may pass to 314. Otherwise, the control may pass to 316.

At 314, a second neural network may be obtained. In an embodiment, the circuitry 202 may be configured to determine the first neural network as the second neural network, which may be pre-trained on the selected computer vision task. Control may pass to 342.

In an embodiment, the circuitry 202 may be configured to execute one or more operations, including a neural architecture search with the seed model and the set of constraints as an input, to obtain the second neural network (which may be trained on the selected computer vision task). The one or more operations may include a determination of a search space that includes a collection of different types of layers and an execution of the neural architecture search within the search space, as described herein.

At 316, a search space may be determined. In an embodiment, the circuitry 202 may be configured to determine the search space that includes a collection of different types of layers. Each of such layers may be referred to as a neural network layer, which may correspond to a set of mathematical operations applied on a set of inputs to the neural network layer. From such layers, one or more layers may be selected and used for a modification or a replacement of one or more existing layers of the seed model. The search space may be limited by constraints, such as a memory constraint that indicates an available temporary memory or storage space to host or execute a neural network (as part of an end-user feature) on the electronic device 104. Details of the search space determination may be known to one skilled in the art, and therefore, a detailed description of the search space has been omitted from the disclosure for the sake of brevity.

At 318, a neural architecture search may be executed. In an embodiment, the circuitry 202 may be configured to execute the neural architecture search within the search space. The search may be executed to generate a second neural network which optimally satisfies the determined set of constraints (or incurs a violation within a permissible range) and is pre-trained on the selected computer vision task. The 320 to 338 describes further operations of the neural architecture search.

In an embodiment, the seed model may be modified in a first iteration as part of the neural architecture search. For example, a first layer may be selected from search space and may replace one of the layers (e.g., dense or drop layers) of the seed model. In addition to the replacement of a layer of the seed model, the neural architecture search may include other modification options, such as but not limited to, a deletion of one or more layers, an addition of one or more layers, a merger of one or more layers, a reduction in stride values between layers, a change in a feature map size, and a change in filter/kernel size for convolutional layers. Details of such options may be known to one skilled in the art. Therefore, a detailed description of such options has been omitted from the disclosure for the sake of brevity.

At 320, a candidate neural network may be generated. In an embodiment, the circuitry 202 may be configured to generate the candidate neural network based on a modification of an architecture of the seed model (or a modification of the first neural network 110). The candidate neural network may be a modified seed model that may or may not be trained on a computer vision task. An example of the modification may include changes in one or more convolution layers of the first neural network 110 to obtain the candidate neural network. Another example of the modification may include a change of a neural network layer of the seed model to one of a 2×2 depthwise convolution layer, a 5×5 2D convolution layer, a 3×3 2D convolution layer, or a maxpool layer. Details of such convolution layer changes may be known to one skilled in the art; and therefore, a detailed description of such modifications has been omitted from the disclosure for the sake of brevity.

At 322, it may be determined whether constraints or performance indicators are satisfied. In an embodiment, the circuitry 202 may be configured to determine whether the set of constraints or one or more performance indicators are satisfied for the candidate neural network. For such determination, the circuitry 202 may evaluate the one or more performance indicators of the candidate neural network and may compare the evaluated performance indicators with reference or threshold values. The evaluation of the one or more performance indicators may be constrained by the determined set of constraints. Example of the evaluated performance indicators may include, but is not limited to, a validation error, a similarity measure (such as Jaccard Index), a model inference accuracy, and an inference speed.

In an embodiment, the neural architecture search may be re-executed based on a determination that the evaluated one or more performance indicators are below the threshold values (for example, numeric values such as 5%, 15%, 20%, and so on). Control may pass to 320.

In an embodiment, the second neural network may be determined to be the candidate neural network, based on a determination that the evaluated one or more performance indicators are above the threshold values. In such a case, control may pass to 324. In another embodiment, the evaluated one or more performance indicators may be determined to be below the threshold values. In such a case, the control may pass to 326.

At 324, a second neural network may be obtained. In an embodiment, the circuitry 202 may be configured to determine the candidate neural network as the second neural network, which may be trained on the selected computer vision task. Control may pass to 342.

At 326, hyperparameters may be configured. In an embodiment, the circuitry 202 may configure hyperparameters of the candidate neural network based on the determined set of constraints. The candidate neural network may be defined by its hyper-parameters, such as activation function(s), a number of weights, a cost function, connections between neurons, a regularization function, an input size, and a number of layers.

The candidate neural network may be referred to as a computational network or a system of artificial neurons (also referred to as nodes). The nodes of the candidate neural network may be arranged in a plurality of layers, as defined in a neural network topology of the candidate neural network. The plurality of layers of the candidate neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the candidate neural network. Outputs of each hidden layer may be coupled to inputs of at least one node in other layers of the candidate neural network. Node(s) in the final layer may receive inputs from at least one hidden layer to output a result. The number of layers and the number of nodes in each layer may be determined from the hyper-parameters of the candidate neural network. Such hyper-parameters may be set before or while training the candidate neural network on a training dataset.

Each node of the candidate neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the candidate neural network. All or some of the nodes of the candidate neural network may correspond to same or a different mathematical function.

The circuitry 202 may be configured to select a training dataset for the selected computer vision task (selected at 306). For example, if the selected computer vision task is an animal or a face detection task, then the selected training dataset may be a labelled dataset of animal or face images of various test subjects. For each image in the labelled dataset, corresponding categorical variable(s) such as a ground truth label may be included in the training dataset.

The circuitry 202 may be configured to train the candidate neural network on the selected computer vision task, based on the selected training dataset. In training of the candidate neural network, one or more parameters (such as neural weights) of each node of the candidate neural network may be updated based on whether an output of the final layer for a given input (from the training dataset) matches a correct result based on a loss function for the candidate neural network. The above process may be repeated for same or a different input till a minima of loss function is achieved, and a training error is minimized. Several methods for training are known in the art, for example, gradient descent, a stochastic gradient descent, a batch gradient descent, a gradient boost, a meta-heuristics, and the like.

At 328, a quantization-aware training process may be executed. In an embodiment, the circuitry 202 may be configured to execute the quantization-aware training process to train the candidate neural network. The quantization-aware training process may be executed to quantize weight parameters of the candidate neural network from a current bit-depth representation to a first bit-depth representation. The quantization-aware training process may be indicative of an operation to modify (i.e. compress or decompress) a neural network (such as the candidate neural network) by quantizing weight parameters of the candidate neural network. For example, if current bit-depth representation for each weight parameters is 32 bit float, then the first bit-depth representation for the respective weight parameter may be changed to 16 bit float or 8 bit Int. Such representation of the weight parameters may change with a change in the hardware specification of the electronic device 104. In the quantization-aware training, the candidate neural network may be trained in order to compensate for loss of accuracy due to quantization of weight parameters of the candidate neural network. Details of the quantization-aware training process may be known to one skilled in the art, and therefore, a detailed description of the quantization-aware training process has been omitted from the disclosure for the sake of brevity.

In an embodiment, the circuitry 202 may be configured to execute a post-training quantization of weight parameters of the trained candidate neural network. The trained candidate neural network, after the post-training quantization, may be the second neural network. In the post-training quantization, the weight parameters of the candidate neural network may be quantized after the training is over. For example, the learned weight parameters may be converted to types with a reduced precision, such as 16 bit floats or 8 bit integers. Details of the post-training quantization process may be known to one skilled in the art, and therefore, a detailed description of the post-training quantization process has been omitted from the disclosure for the sake of brevity.

The quantization-aware training and/or the post-training quantization may help to reduce model size while also improving CPU/GPU and hardware accelerator latency, with a little to no degradation in model accuracy. This may help to obtain a second neural network that satisfies the set of constraints (e.g., memory/storage size constraints) and is trained for the selected computer vision task.

At 330, a pruning operation may be executed. In an embodiment, the circuitry 202 may be configured to execute the pruning operation on weight parameters of the trained candidate neural network. The pruning operation may include an operation to modify (such as to compress) a neural network (such as the candidate neural network) by removing unwanted nodes of the candidate neural network arranged in a plurality of layers. Such unwanted nodes may include nodes that have minimal or no significance in training of the candidate neural network. For example, the nodes having have minimal or no significance weight (e.g., weight, w≅0) may be denoted as unwanted nodes as they may have no significance in training of the candidate neural network. Details of the pruning operation may be known to one skilled in the art, and therefore, a detailed description of the pruning operation has been omitted from the disclosure for the sake of brevity.

At 332, it may be determined whether constraints or performance indicators are satisfied. The circuitry 202 may be configured to determine whether the set of constraints or the one or more performance indicators are satisfied for the trained candidate neural network (obtained after the pruning and quantization operations).

In an embodiment, the circuitry 202 may evaluate the one or more performance indicators of the trained candidate neural network and may compare the evaluated performance indicators with reference or threshold values. The evaluation of the one or more performance indicators and the training may be constrained by the determined set of constraints. Examples of the evaluated performance indicators may include, but is not limited to, a validation error, a similarity measure (such as Jaccard Index), a model inference accuracy, and an inference speed.

In an embodiment, the circuitry 202 may be configured to compare with the set of constraints, device resources that the trained candidate neural network may consume. If the device resources consumed by the trained candidate neural network satisfies the set of constraints or incurs a violation within a permissible range, then the circuitry 202 may be configured to obtain trained candidate neural network (after the pruning/quantization) as the second neural network and control may pass to 334. If the device resources consumed by the trained candidate neural network dissatisfies the set of constraints or incurs a violation in outside the permissible range, then the control may pass to 336.

At 334, a second neural network may be obtained. In an embodiment, after the execution of the pruning operation, the circuitry 202 may be configured to determine the trained candidate neural network as the second neural network. The second neural network may be trained on the selected computer vision task and may be ready for deployment as an end-user feature of a software application, such as an imaging software on the electronic device 104. Control may pass to 342.

At 336, a knowledge distillation operation may be executed. In an embodiment, the circuitry 202 may be configured to execute the knowledge distillation operation. The knowledge distillation operation may correspond to a training of a smaller neural network using a larger pre-trained neural network. Here, the larger neural network may be trained on a large training dataset for a greater amount of training time. For a specific computer vision task, the accuracy of the larger neural network may match that of a state of the art neural network. The smaller neural network may be trained based on a subset of inferences produced by the larger neural network. In training of the smaller neural network, one or more parameters of each node of the smaller neural network may be updated based on whether an output of the final layer for a given input (from the training dataset) matches a correct result (such as the larger neural network) based on a loss function for the smaller neural network.

By way of example, and not limitation, the larger neural network and the smaller neural network may be collectively referred to as teacher-student models. The circuitry 202 may be configured to select a teacher neural network (i.e. the larger neural network) pre-trained on the selected computer vision task. Thereafter, the circuitry 202 may be configured to select the candidate neural network as a student network (i.e. the smaller neural network). The circuitry 202 may train the candidate neural network based on inferences, produced by the teacher neural network using the training dataset. Details of the knowledge distillation operation may be known to one skilled in the art, and therefore, a detailed description of the knowledge distillation operation has been omitted from the disclosure for the sake of brevity.

At 338, it may be determined whether constraints or performance indicators are satisfied. The circuitry 202 may be configured to determine whether the set of constraints or the one or more performance indicators are satisfied for the trained candidate neural network (i.e. the trained student neural network).

In an embodiment, the circuitry 202 may evaluate the one or more performance indicators of the trained candidate neural network (i.e. the trained student neural network) and may compare the evaluated performance indicators with reference or threshold values. The evaluation of the one or more performance indicators and the training may be constrained by the determined set of constraints. Example of the evaluated performance indicators may include, but is not limited to, a validation error, a similarity measure (such as Jaccard Index), a model inference accuracy, and an inference speed.

In an embodiment, the neural architecture search may be re-executed, and control may pass to 320, based on a determination that the evaluated one or more performance indicators are below a threshold. In another embodiment, the second neural network may be determined to be the trained candidate neural network (i.e. the trained student neural network), based on a determination that the evaluated one or more performance indicators are above a threshold. In such a case, control may pass to 340.

In an embodiment, the circuitry 202 may be configured to compare with the set of constraints, device resources that the trained candidate neural network may consume. If the device resources consumed by the trained candidate neural network (i.e. the trained student neural network) satisfies the set of constraints or incurs a violation within a permissible range, then the circuitry 202 may be configured to obtain trained candidate neural network as the second neural network and control may pass to 340. If the device resources consumed by the trained candidate neural network dissatisfies the set of constraints or incurs a violation in outside the permissible range, then the control may pass to 320.

At 340, a second neural network may be obtained. In an embodiment, the circuitry 202 may obtain the trained candidate neural network as the second neural network. The second neural network may be trained on the selected computer vision task and may be ready for deployment as an end-user feature of a software application, such as an imaging software on the electronic device 104. Control may pass to 342.

At 342, the software application (such as the software application 112) may be updated. In an embodiment, the circuitry 202 may be configured to update the software application 112 on the electronic device 104 to include an end-user feature that implements the second neural network for the selected computer vision task. The end-user feature may be indicative of functionality to be included in the software application 112 for the implementation of the selected computer vison task. As an example, the end user feature may include classification of cats in an object classification task. As another example, the end-user feature may include classification of cats and dogs in an object classification+ task, and classification of cats, dogs, and humans in object classification pro task, as depicted for example, on a display device 344 associated with the electronic device 104.

In some embodiments, the update of the software application 112 may include a replacement of an existing neural network model on the electronic device 104 with the second neural network, an installation of the second neural network as a component of the software application 112 on the electronic device 104, and an update of parameters, including weight parameters of an existing neural network on the electronic device 104 with that of the second neural network. In these or other embodiments, the replacement of the existing neural network model with the second neural network may include a replacement of an existing imaging software installed on the electronic device 104 with a new imaging software that includes the end-user feature.

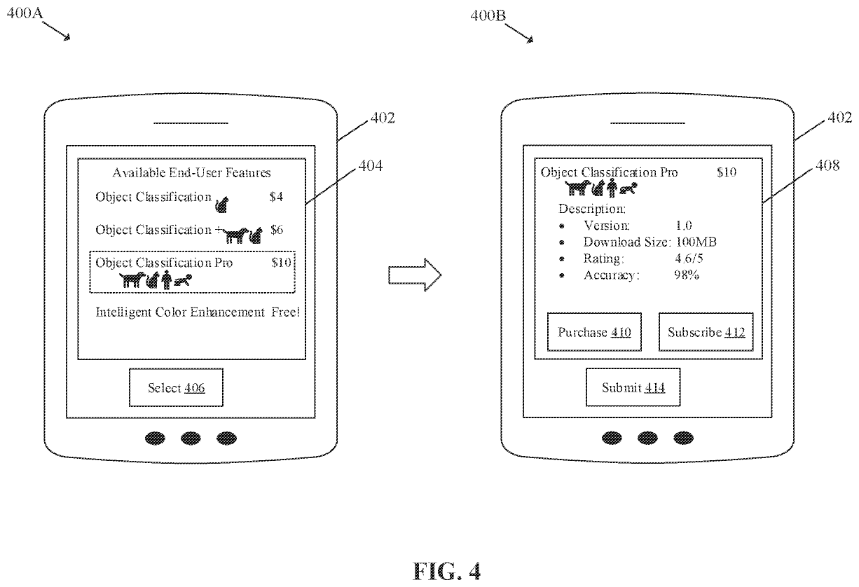

FIG. 4 is a diagram that illustrates an exemplary user interface for customization of software applications with neural network-based features, in accordance with an embodiment of the disclosure. FIG. 4 is explained in conjunction with elements from FIGS. 1, 2, 3A, 3B, and 3C. With reference to FIG. 4, there is shown an electronic device 402 as an exemplary implementation of the electronic device 104 of FIG. 1. The electronic device 402 may display a User Interface (UI) that may include a plurality of user interface (UI) elements. As an example, there is shown a first UI element 404, and a second UI element 406.

The circuitry 202 may be configured to control the electronic device 402 to display a User Interface (UI) that includes a list of available end-user features, a first option to purchase an end-user feature, a second option to subscribe to the end-user feature, a description that includes an accuracy of the second neural network, details of device resources that the end-user feature is likely to consume, and a price associated with each of the first option and the second option

The first UI element 404 may be, for example, a list box that may be configured to receive a user input indicative of a selection an end-user feature of the available end-user features. Based on the user input, the circuitry 202 may select the end-user feature (as represented by dashed box). As shown, for example, the circuitry 202 may be configured to select object classification Pro as the end-user feature (described, for example, in FIGS. 3A, 3B, and 3C). It should be noted that the available end-user features in FIG. 4 are presented merely an example and should not be construed as limiting. The second UI element 406 may be, for example, a button (such as a “Select” button) that may be configured to receive a user confirmation to select one or more of the available end-user features.

There is further shown a third UI element 408, which may be, for example, a description box that includes an accuracy of the second neural network and details of device resources that the selected end-user feature is likely to consume. For example, there is shown in the third UI element 408, a price (such as $10) of the selected end-user feature, a version (such as 1.0) of the selected end-user feature, a download size (such as 100 MB) of the selected end-user feature, a rating (such as 4.6/5) of the selected end-user feature, and an accuracy (such as 98%) of the second neural network implemented by the selected end-user feature. It should be noted that the description shown in FIG. 4 is merely an example and should not be construed as limiting.

A fourth UI element 410 may be, for example, a button (such as a “Purchase” button) that may be configured to receive a user confirmation to purchase the selected end-user feature based on the received user input. A fifth UI element 412 may be, for example, a button (such as a “Subscribe” button) that may be configured to receive a user confirmation to subscribe the selected end-user feature based on the received user input. A sixth UI element 414 may be, for example, a button (such as a “Submit” button) that may be configured to receive a selection of at least one of a purchase option or subscribe option, via the electronic device 402. The software application 112 may be updated based on the received selection.

In an embodiment, the first option (purchase option) and the second option (subscribe option) may be included in the UI, based on the acquired usage data. The circuitry 202 may be configured to analyze the user preference 304C and the usage pattern 304D to predict user preference associated with purchase or subscribe options. Thereafter, the display device may be controlled to display the first option and the second option on the UI.

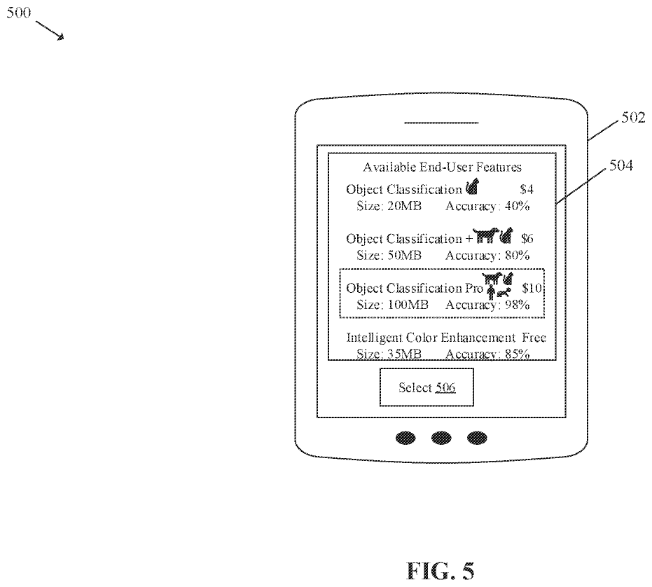

FIG. 5 is a diagram that illustrates an exemplary user interface for customization of software applications with neural network-based features, in accordance with an embodiment of the disclosure. FIG. 5 is described in conjunction with elements from FIGS. 1, 2, 3A, 3B, 3C, and 4. With reference to FIG. 5, there is shown an electronic device 502 as an exemplary implementation of the electronic device 104 of FIG. 1. The electronic device 502 may display a User Interface (UI) that may include a plurality of user interface (UI) elements. As an example, there is shown a first UI element 504 and a second UI element 506.

The first UI element 504 may be, for example, a list box that may be configured to receive a user input indicative of a selection of an end-user feature of available end-user features. Based on the user input, the circuitry 202 may select the end-user feature (as depicted by dashed box). As shown, for example, the selected end-user feature may be object classification pro. It should be noted that the available end-user features in FIG. 5 are presented merely as example and should not be construed as limiting. The second UI element 506 may be, for example, a button (such as a “Select” button) to select the end-user feature.

In an embodiment, the circuitry 202 may be configured to determine the price based on one or more of a cost of the electronic device 104 or a functional component of the electronic device 104, a total time including a training time to obtain the second neural network from the seed model, a complexity of the end-user feature, a cost of dataset that may be used to obtain the second neural network, competitive or business intelligence data on users of the electronic device 502, and an estimate-demand for the end-user feature. When the cost of the electronic device 104 or the functional component of the electronic device 104 is high, the circuitry 202 may be configured to determine the price for the selected end-user feature to be a higher than an average price. For example, the price may be high, when large amount of time is consumed in order to train and obtain the second neural network, the end-user features are complex, estimate-demand of the end-user feature is high, and the dataset is costly. The price may be low, when the competition in the market is very high and the cost of the electronic device 104 is low. The price may be high, when the seed model is not available for the selected computer vision task and a new model needs to be developed.

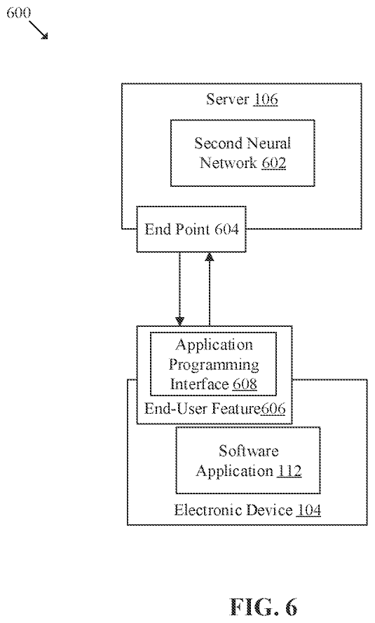

FIG. 6 is a diagram that illustrates an exemplary scenario for customization of software applications with neural network-based features, in accordance with an embodiment of the disclosure. FIG. 6 is described in conjunction with elements from FIGS. 1, 2, 3A, 3B, 3C, 4, and 5. With reference to FIG. 6, there is shown an exemplary scenario 600 for customization of software applications with neural network-based features.

In an embodiment, the circuitry 202 may be further configured to deploy a second neural network 602 on the server 106. The second neural network may be obtained from the seed model, as described for example, in FIG. 3A and 3B. The circuitry 202 may be configured to determine an end point 604 to implement the second neural network 602 on the electronic device 104. The end point 604 may correspond to a uniform resource locator (URL) to be used to call the second neural network 602 deployed on the server 106.

The circuitry 202 may be configured to update the software application 112 on the electronic device 104 to include the end-user feature 606 that may implement the second neural network 602 for the selected computer vision task, as described in for example, FIG. 3C. In an embodiment, the software application 112 may be updated with an Application Programming Interface (API) call functionality 608. The API call functionally 608 includes an API call code to remotely call the second neural network 602. The circuitry 202 may be configured to control the software application 112 to call the server 106 using the API call functionally 608. The call may include a payload, such as an image that the user may want to run a computer vision task on. Based on the call, the circuitry 202 may be configured to pass the payload to the second neural network 602 on the server 106 and may receive a result or an output produced by the second neural network 602 on the electronic device 104.

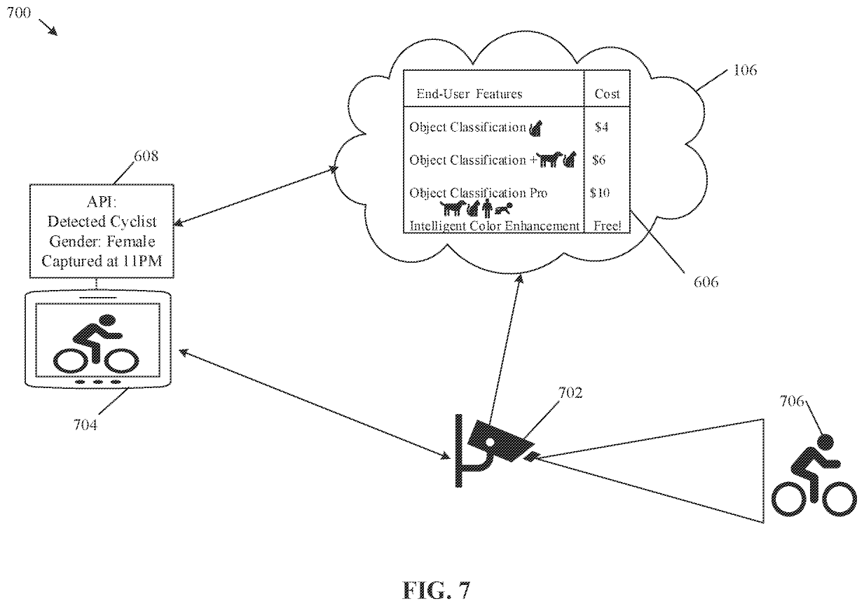

FIG. 7 is a diagram that illustrates exemplary scenario for customization of software applications with neural network-based features, in accordance with an embodiment of the disclosure. FIG. 7 is described in conjunction with elements from FIGS. 1, 2, 3A, 3B, 3C, 4, 5, and 6. With reference to FIG. 7, there is shown an exemplary scenario 700. The scenario 700 may depict customization of software applications with neural network-based features. The scenario 700 may include an electronic device 702 and a display device 704 associated with the electronic device 702.

The electronic device 702 may be an image capture device, for example CCTV camera, as shown in FIG. 7. The circuitry 202 may be acquire information related to one or more functional components of the electronic device 702 and usage data associated with the electronic device 702, as described, for example, in FIG. 3A. The circuitry 202 may determine a set of constraints associated with an implementation of the selected computer vision task on the electronic device 702 and may select the first neural network 110 as a seed model for the selected computer vision task as described, for example, in FIG. 3A.

The circuitry 202 may select a first neural network 110 as a seed model for the selected computer vision task and may execute the one or more operations, including but not limited to, a neural architecture search with the seed model and the set of constraints as input to obtain the second neural network 602. The second neural network 602 may be trained on the selected computer vision task, as described, for example, in FIGS. 3A, and 3B. The circuitry 202 may be configured to update the software application 112 on the electronic device 104 to include the end-user feature 606 that implements the second neural network 602 for the selected computer vision task, as described, for example, in FIG. 3C.

There is further shown a cyclist 706. The electronic device 702 may be configured to capture an image of the cyclist 706. The circuitry 202 may control the display device 704 to display the captured image. To detect the cyclist (i.e. a computer vision task), the circuitry 202 may call the second neural network 602 on the server 106 with the captured image as input. In response to the call, the second neural network 602 may generate an inference, for example, “detected: cyclist, gender: female, captured at 11 pm”.

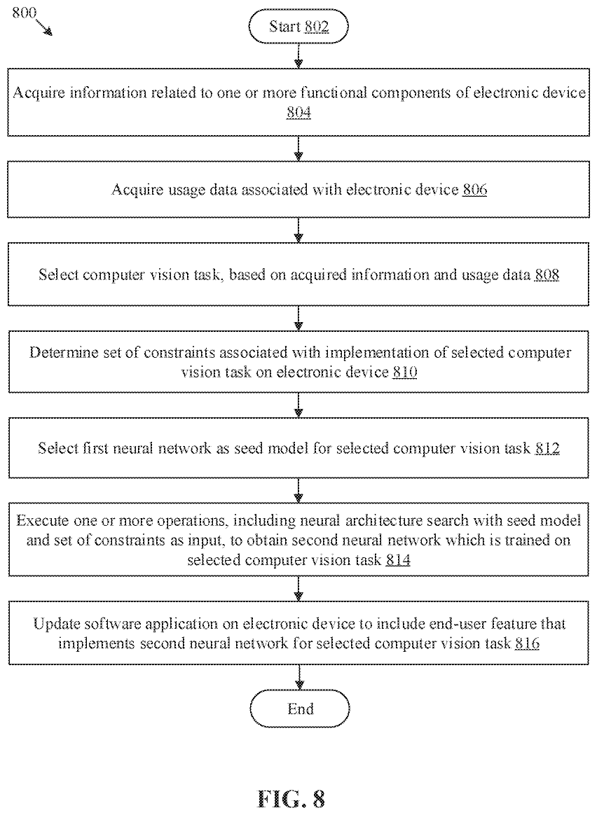

FIG. 8 is a flowchart that illustrates exemplary operations for customization of software applications with neural network-based features, in accordance with an embodiment of the disclosure. FIG. 8 is described in conjunction with elements from FIGS. 1, 2, 3A, 3B, 3C, 4, 5, 6, and 7. With reference to FIG. 8, there is shown a flowchart 800. The flowchart 800 may include operations from 802 to 816 and may be implemented on the system 102. The flowchart 800 may start at 802 and proceed to 804.

At 804, information related to one or more functional components may be acquired. In an embodiment, the circuitry 202 may be configured to acquire information related to one or more functional components of an electronic device 104. The acquisition of the information is described, for example, in FIGS. 3A, 3B, and 3C.

At 806, usage data may be acquired. In an embodiment, the circuitry 202 may be configured to acquire usage data associated with the electronic device 104. The acquisition of the usage data is described, for example, in FIGS. 3A, 3B, and 3C.

At 808, a computer vision task may be selected. In an embodiment, the circuitry 202 may be configured to select the computer vision task, based on the acquired information and the usage data. The selection of the computer vision task is described, for example, in FIGS. 3A, 3B, and 3C.

At 810, a set of constraints 308A may be determined. In an embodiment, the circuitry 202 may be configured to determine the set of constraints associated with an implementation of the selected computer vision task on the electronic device 104. The determination of the set of constraints is described, for example, in FIGS. 3A, 3B, and 3C.

At 812, a seed model may be selected. In an embodiment, the circuitry 202 may be configured to select a first neural network 110 as a seed model for the selected computer vision task. The selection of the seed model is described, for example, in FIGS. 3A, 3B, and 3C.

At 814, one or more operations may be executed. In an embodiment, the circuitry 202 may be configured to execute the one or more operations, including a neural architecture search with the seed model and the set of constraints as an input, to obtain a second neural network 602 which is trained on the selected computer vision task. The execution of the one or more operations is described, for example, in FIGS. 3A, 3B, and 3C.

At 816, a software application 112 may be updated. In an embodiment, the circuitry 202 may be configured to update the software application 112 on the electronic device 104 to include an end-user feature 606 that implements the second neural network 602 for the selected computer vision task. The update of the software application 112 is described, for example, in FIGS. 3A, 3B, and 3C. Control may pass to end.

Although the flowchart 800 is illustrated as discrete operations, such as 804, 806, 808, 810, 812, 814, and 816, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer readable medium and/or storage medium having stored thereon, instructions executable by a machine and/or a computer to operate a system (for example, the system 102). The instructions may cause the system 102 to perform operations that include acquire information related to one or more functional components of an electronic device 104. The operations may further include acquire usage data associated with the electronic device 104. The operations may further include selection of a computer vision task, based on the acquired information and the usage data. The operations may further include determination of a set of constraints associated with an implementation of the selected computer vision task on the electronic device 104. The operations may further include selection of a first neural network 110 as a seed model for the selected computer vision task. The operations may further include execution one or more operations, including a neural architecture search with the seed model and the set of constraints as an input, to obtain a second neural network which is trained on the selected computer vision task. The operations may further include update of a software application 112 on the electronic device 104 to include an end-user feature that implements the second neural network for the selected computer vision task.

Exemplary aspects of the disclosure may provide a system (such as, the system 102 of FIG. 1) that includes circuitry (such as, the circuitry 202). The circuitry 202 may be configured to acquire information related to one or more functional components of an electronic device 104. The circuitry 202 may be further configured to acquire usage data associated with the electronic device 104. The circuitry 202 may be further configured to select a computer vision task, based on the acquired information and the usage data. The circuitry 202 may be further configured to determine a set of constraints associated with an implementation of the selected computer vision task on the electronic device 104. The circuitry 202 may be further configured to select a first neural network 110 as a seed model for the selected computer vision task. The circuitry 202 may be further configured to execute one or more operations, including a neural architecture search with the seed model and the set of constraints as an input, to obtain a second neural network which is trained on the selected computer vision task. The circuitry 202 may be further configured to update a software application 112 on the electronic device 104 to include an end-user feature that implements the second neural network for the selected computer vision task.

In an embodiment, the electronic device 104 may be an image-capture device and the software application 112 may be an imaging software installed on the electronic device 104.

In an embodiment, the acquired information comprises hardware specification of the one or more functional components. The set of constraints may include one or more hardware-specific constraints, which are determined based on the hardware specification.

In an embodiment, the acquired information may further include cost information associated with the one or more functional components. The set of constraints may include one or more cost constraints, which are determined based on the cost information.

In an embodiment, the acquired usage data may include a digital footprint on the software application 112, a set of category tags related to image-based content created through the software application 112, a user preference for the image-based content on the electronic device 104, and a usage pattern of existing functionalities that implement a type of neural network for one or more computer vision tasks.

In an embodiment, the execution of the one or more operations may include a determination of a search space that includes a collection of different types of layers, and the execution of the neural architecture search within the search space to: generate a candidate neural network based on a modification of an architecture of the seed model, configure hyperparameters of the candidate neural network based on the determined set of constraints, select a training dataset for the selected computer vision task, and train, based on the configuration, the candidate neural network on the selected computer vision task, based on the selected training dataset.

In an embodiment, the circuitry 202 may be further configured to execute a quantization-aware training process to train the candidate neural network. The quantization-aware training process may be executed to quantize weight parameters of the candidate neural network from a current bit-depth representation to a first bit-depth representation.

In an embodiment, the execution of the one or more operations further comprises execution of a pruning operation on weight parameters of the trained candidate neural network. The trained candidate neural network, after the execution of the pruning operation, may be the second neural network.

In an embodiment, the execution of the one or more operations further include a post-training quantization of weight parameters of the trained candidate neural network. The trained candidate neural network, after the post-training quantization, may be the second neural network.

In an embodiment, the one or more operations further comprises a knowledge distillation operation, which may be executed to select a teacher neural network which is pre-trained on the selected computer vision task, select the candidate neural network as a student network. The candidate neural network is trained based on inferences, produced by the teacher neural network using the training dataset.

In an embodiment, the circuitry 202 may be configured to evaluate one or more performance indicators of the trained candidate neural network. The evaluation of the one or more performance indicators and the training may be constrained by the determined set of constraints.

In an embodiment, the neural architecture search may be re-executed based on a determination that the evaluated one or more performance indicators are below a threshold.

In an embodiment, the second neural network may be determined to be the trained candidate neural network, based on a determination that the evaluated one or more performance indicators are above a threshold.

In an embodiment, the circuitry 202 may be further control the electronic device to display a User Interface (UI) that includes one or more of a first option to purchase the end-user feature, a second option to subscribe to the end-user feature, a description that includes an accuracy of the second neural network and details of device resources that the end-user feature is likely to consume, and a price associated with each of the first option and the second option. The circuitry 202 may be configured to receive a selection of the first option or the second option, via the electronic device 104. The software application may be updated based on the received selection.

In an embodiment, the first option and the second option may be included in the UI, based on the acquired usage data.

In an embodiment, the circuitry 202 may be further configured to determine the price based on one or more of a cost of the electronic device 104 or a functional component of the electronic device 104, a total time, including a training time to obtain the second neural network from the seed model, a complexity of the end-user feature, a cost of dataset that is used to obtain the second neural network, competitive or business intelligence data on users of the electronic device 104, and an estimate-demand for the end-user feature.

In an embodiment, the update of the software application may include a replacement of an existing neural network model on the electronic device 104 with the second neural network, an installation of the second neural network as a component of the software application on the electronic device 104, and an update of parameters, including weight parameters of an existing neural network on the electronic device 104 with that of the second neural network.

In an embodiment, the circuitry 202 may be further configured to deploy the second neural network on a server 106. The software application may be updated with an Application Programming Interface (API) call functionality, wherein the API call functionally includes an API call code to remotely call the second neural network

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A system, comprising:
circuitry configured to:
acquire information related to one or more functional components of an electronic device;
acquire usage data associated with the electronic device;
select a computer vision task, based on the acquired information and the usage data;
determine a set of constraints associated with an implementation of the selected computer vision task on the electronic device;
select a first neural network as a seed model for the selected computer vision task;
execute one or more operations, including a neural architecture search with the seed model and the set of constraints as an input, to obtain a second neural network which is trained on the selected computer vision task; and
update a software application on the electronic device to include an end-user feature that implements the second neural network for the selected computer vision task.

2. The system according to claim 1, wherein the electronic device is an image-capture device and the software application is an imaging software installed on the electronic device.

3. The system according to claim 1, wherein the acquired information comprises hardware specification of the one or more functional components, and
the set of constraints includes one or more hardware-specific constraints, which are determined based on the hardware specification.

4. The system according to claim 1, wherein the acquired information further includes cost information associated with the one or more functional components, and
the set of constraints includes one or more cost constraints, which are determined based on the cost information.

5. The system according to claim 1, wherein the acquired usage data comprises:
a digital footprint on the software application,
a set of category tags related to image-based content created through the software application,
a user preference for the image-based content on the electronic device, and
a usage pattern of existing functionalities that implement a type of neural network for one or more computer vision tasks.

6. The system according to claim 1, wherein the execution of the one or more operations comprises:
a determination of a search space that includes a collection of different types of layers; and
the execution of the neural architecture search within the search space to:
generate a candidate neural network based on a modification of an architecture of the seed model;
configure hyperparameters of the candidate neural network based on the determined set of constraints;
select a training dataset for the selected computer vision task; and
train the candidate neural network on the selected computer vision task, based on the selected training dataset.

7. The system according to claim 6, wherein the circuitry is further configured to execute a quantization-aware training process to train the candidate neural network, and wherein the quantization-aware training process is executed to quantize weight parameters of the candidate neural network from a current bit-depth representation to a first bit-depth representation.

8. The system according to claim 6, wherein the execution of the one or more operations further comprises execution of a pruning operation on weight parameters of the trained candidate neural network, and
the trained candidate neural network, after the execution of the pruning operation, is the second neural network.

9. The system according to claim 6, wherein the execution of the one or more operations further comprises a post-training quantization of weight parameters of the trained candidate neural network, and
the trained candidate neural network, after the post-training quantization, is the second neural network.

10. The system according to claim 6, wherein the one or more operations further comprises a knowledge distillation operation, which is executed to:
select a teacher neural network which is pre-trained on the selected computer vision task, and
select the candidate neural network as a student network,
wherein the candidate neural network is trained based on inferences, produced by the teacher neural network using the training dataset.

11. The system according to claim 6, wherein the circuitry is further configured to evaluate one or more performance indicators of the trained candidate neural network, and
wherein the evaluation of the one or more performance indicators and the training are constrained by the determined set of constraints.

12. The system according to claim 11, wherein the neural architecture search is re-executed based on a determination that the evaluated one or more performance indicators are below a threshold.

13. The system according to claim 11, wherein the second neural network is determined to be the trained candidate neural network, based on a determination that the evaluated one or more performance indicators are above a threshold.

14. The system according to claim 1, wherein the circuitry is further configured to:
control the electronic device to display a User Interface (UI) that includes one or more of:
a first option to purchase the end-user feature,
a second option to subscribe to the end-user feature,
a description that includes an accuracy of the second neural network and details of device resources that the end-user feature is likely to consume, and
a price associated with each of the first option and the second option; and
receive a selection of the first option or the second option, via the electronic device,
wherein the software application is updated based on the received selection.

15. The system according to claim 14, wherein the first option and the second option are included in the UI, based on the acquired usage data.

16. The system according to claim 14, wherein the circuitry is further configured to determine the price based on one or more of:
a cost of the electronic device or a functional component of the electronic device,
a total time, including a training time to obtain the second neural network from the seed model,
a complexity of the end-user feature,
a cost of dataset that is used to obtain the second neural network,
competitive or business intelligence data on users of the electronic device, and
an estimate-demand for the end-user feature.

17. The system according to claim 1, wherein the update of the software application comprises:
a replacement of an existing neural network model on the electronic device with the second neural network,
an installation of the second neural network as a component of the software application on the electronic device, and
an update of parameters, including weight parameters of an existing neural network on the electronic device with that of the second neural network.

18. The system according to claim 1, wherein the circuitry is further configured to deploy the second neural network on a server, wherein
the software application is updated with an Application Programming Interface (API) call functionality, wherein the API call functionally includes an API call code to remotely call the second neural network.

19. A method, comprising:
in a system:
acquiring information related to one or more functional components of an electronic device;
acquiring usage data associated with the electronic device;
selecting a computer vision task, based on the acquired information and the usage data;
determining a set of constraints associated with an implementation of the selected computer vision task on the electronic device;
selecting a first neural network as a seed model for the selected computer vision task;
executing one or more operations, including a neural architecture search with the seed model and the set of constraints as an input, to obtain a second neural network which is trained on the selected computer vision task; and
updating a software application on the electronic device to include an end-user feature that implements the second neural network for the selected computer vision task.

20. A non-transitory computer-readable medium having stored thereon, computer-executable instructions that when executed by a computer in a system, causes the system to execute operations, the operations comprising:
acquiring information related to one or more functional components of an electronic device;
acquiring usage data associated with the electronic device;
selecting a computer vision task, based on the acquired information and the usage data;
determining a set of constraints associated with an implementation of the selected computer vision task on the electronic device;
selecting a first neural network as a seed model for the selected computer vision task;
executing one or more operations, including a neural architecture search with the seed model and the set of constraints as an input, to obtain a second neural network which is trained on the selected computer vision task; and
updating a software application on the electronic device to include an end-user feature that implements the second neural network for the selected computer vision task.
